(19) United States
(12) Patent Application Publication
(10) Pub. No.: US 2008/0099951 A1
(43) Pub. Date: May 1, 2008

(54) ANNULAR FEEDBLOCK FOR COEXTRUDED FILM, AND METHODS

(75) Inventors: Gibson L. Batch, St. Paul, MN (US); Christopher C. Kent, Woodbury, MN (US); Ronald W. Ausen, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/554,992

(22) Filed: Oct. 31, 2006

(51) Int. Cl. B29C 47/06

(52) U.S. Cl. 264/173.11; 264/173.16

(57) ABSTRACT

A feedblock for a film extruder used to produce a uniform, multiple layer web. The feedblock has a generally annular configuration, for receipt of a core material and a skin material. The feedblock has a varying radial dimension for passage of the skin material therethrough. After feeding the core material and the skin material through the feedblock and then a die, a flat web having at least three layers, uniform across the web width, is obtained.

### FIELD

The present disclosure relates to extrusion apparatus used for extrusion of multiple layer films or webs.

### BACKGROUND

There is always the desire to reduce the cost of manufactured goods. Multiple layer (or multi-layer) plastic materials are no different.

There are generally two different methods to obtain a plastic or polymeric composite material having two or more different materials; these methods are lamination and coextrusion. These techniques have in common the bringing together in layered form, films of two or more different polymeric or plastic materials.

In lamination, two or more previously extruded films are brought together under pressure and temperature conditions or in the presence of adhesive in order to adhere the films to one another.

For coextrusion, two different techniques are most often used. In one of these techniques, two or more films are extruded from separate extruders through separate film or sheet dies, the films being in contact with one another while still hot and then passed through a set of rollers and down a film line. The other coextrusion technique uses an adaptor, feedblock, multi-manifold die, or other mechanism to bring two or more different materials from two or more extruders into contact with one another prior to their passage through an extrusion die. Some known coextrusion processes using this technique use some form of encapsulation technique wherein one stream of polymeric material is completely surrounded, e.g., coaxially, by a second stream of a different material prior to passing the entire composite stream through an extrusion die. Annular feedblocks have been used to encapsulate materials and provide a multiple layer film having a core layer and two exterior skin layers.

In either coextrusion instance, the resulting film product has an inner (core) layer of one type of polymeric material sandwiched between or encapsulated by two exterior layers of a second material. One of the undesirable results of the known methods of encapsulation is that the exterior layers can vary in thickness across the width of the extruded web, with the center of the web having the thinnest exterior layers and the edges of the web having the thickest exterior layers and possibly having no interior layer at all.

The invention of the present disclosure provides better equipment and a process for coextrusion of a multiple layer film that is more consistent across the web width.

### SUMMARY

The present disclosure is directed to a feedblock for a film extruder and methods of using the feedblock, in conjunction with a film or sheet die, to produce a multiple layer web having at least three layers that are generally uniform across the web width. For example, webs of five layers, seven layers, and more, can be made with the feedblock of the present disclosure.

The feedblock feeds the extrudable materials, having a generally circular cross-section, to a film or sheet die, from which is obtained a web of material. The multiple layered web has at least three layers, which are generally even across the width of the web.

The feedblock has a generally annular configuration, for passage of an extrudable core material through the center. The feedblock includes a manifold for passage of extrudable skin material around the core material. The manifold has a manifold land across which the extrudable skin material passes. The manifold land defines a gap through which the extrudable skin material passes. The manifold is constructed to provide the skin material around the core material at varying volumetric flow rates. Generally, the skin material is provided at a lower flow rate at the portions of the manifold that provide the edges of the resulting web material, than at the portions of the manifold that provide the center of the resulting web material.

In one design, the land gap varies, providing a narrower gap for passage of the edge material than for the center material. In other words, the area of passage for the extrudable skin material varies around the circumference of the feedblock. In another design, the land length varies, providing a longer distance across the manifold land for the edge material than for the center material. As the extrudable skin material passes from the manifold to the outlet of the feedblock, the varying land gap or the varying land length provides a varying thickness ring of extrudable skin material. The resulting extrudable composition, of the extrudable core material surrounded by an uneven layer of extrudable skin material, is then fed into a film or sheet die to form a web of multi-layer material.

The resulting layered web or film has at least three layers: a core layer formed from the core material, and two surface or skin layers formed from the skin material, one skin layer on each side of the core layer. The thickness of each of the layers is generally consistent across the width or transverse direction of the web.

In one particular embodiment, this disclosure provides an annular feedblock having a first block half and a second block half adapted to be joined to the first block half. An annular manifold is present between the first block half and the second block half, the manifold having a land, with the manifold and the land at least partially defined by an insert element removable from the second block half. The manifold and the land can be at least partially defined by the at least one insert element and at least partially defined by the second block half. The manifold and the land can have a geometry that differs between the second block half and the at least one insert element, the differing geometry being, for example, the gap formed by the land or the land length.

In another particular embodiment, this disclosure provides an annular feedblock having a first block half and a second block half adapted to be joined to the first block half. An annular manifold is present between the first block half and the second block half, the annular manifold having a first portion with a first land and a second portion with a second land, the first land being different than the second land. The first land can be longer than the second land, or, the first land can define a first gap that is less than a second gap defined by the second land. A tapered area can be present between the first land and the second land.

In yet another particular embodiment, this disclosure provides a method of extruding a multiple layer film, the method including providing an annular feedblock in flow communication with a film or sheet die, the annular feedblock having a first portion having a first manifold portion with a first land and a second portion having a second manifold portion with a second land, the first land being different than the second land, feeding a first extrudable material axially through the feedblock and simultaneously feeding a second extrudable material radially into the feedblock, extruding the second extrudable material from the manifold across the first land and the second land in an annular form around the first extrudable material to provide a combined extrudable stream, passing the extrudable stream through the film or sheet die to form a multiple layer film. The multiple layer film can have three or more layers, for example, four layers, five layers, six layers, etc. The method can include extruding the second extrudable material from the manifold and across the first land and the second land at different volumetric flow rates.

The present disclosure also provides a multi-layered film, which, immediately out of the die and prior to slitting or edging trimming, has a first edge and a second edge parallel to the first edge, a first outer layer having a first thickness, a core layer having a second thickness, and a second outer layer having the first thickness. Any edge bead or other discontinuity at the film edge extends no more than 0.5 inch (about 1.27 cm) from the edge, and in some embodiments, extends no more than 0.25 inch (about 0.635 cm) from the edge. In other embodiments, there is no edge bead or other edge discontinuity in the center 95% of the film; any edge discontinuity occurs in no more than the outermost 2.5% of each side edge. In some embodiments, any discontinuity occurs in no more than the outermost 1% of each side edge.

These and other embodiments are described in the present disclosure.

### BRIEF DESCRIPTION OF THE DRAWING

FIG. 1 is a perspective view of a schematic, general configuration of an annular feedblock operably connected to a film or sheet die, illustrating the flow of two extrudable materials therethrough;

FIG. 1a is an enlarged view of a portion of the multi-layer film of FIG. 1;

FIG. 1b is an enlarged view of a second embodiment of a multi-layer film, similar to that of FIG. 1a;

FIG. 2 is a schematic section view orthogonal to the flow of extrudable materials of a prior art feedblock;

FIG. 3 is schematic section view orthogonal to the flow of extrudable materials of a feedblock according to the present disclosure;

FIG. 4 is a perspective view of a feedblock according to the present invention having two blocks;

FIG. 5 is a cross-sectional view of the feedblock of FIG. 4 taken along line 5-5;

FIG. 6 is a perspective view of one half of the feedblock of FIG. 4, the half being in a first configuration;

FIG. 7 is a perspective view of the block of FIG. 6 in a second configuration;

FIG. 8 is a first perspective view of an insert for use with the block of FIG. 7;

FIG. 9 is a second perspective view of the insert of FIG. 8;

FIG. 10 is a top view of the insert of FIGS.8 and 9;

FIG. 11 is a side view of the insert of FIGS. 8 through 10; and

FIG. 12 is a graphical representation of test results from the experimental section herein.

### DETAILED DESCRIPTION

The present disclosure is directed to a feedblock for a film extruder to produce a multiple layer web, film or sheet having at least three layers that are uniform across the web width. The terms “web”, “film” and “sheet” are used interchangeably herein, and no distinction is made between these terms.

The feedblock has an annular configuration, for passage of an extrudable core material therethrough, typically through the center, and an annular manifold for passage of extrudable skin material. The manifold has an annular land with a varying geometry, such as a radial dimension or width, which results in a varying thickness of extrudable skin material surrounding the extrudable core material. The resulting extrudable composition (i.e., the extrudable core material surrounded by an uneven layer of extrudable skin material) is then fed into a film or sheet die to form a web of material.

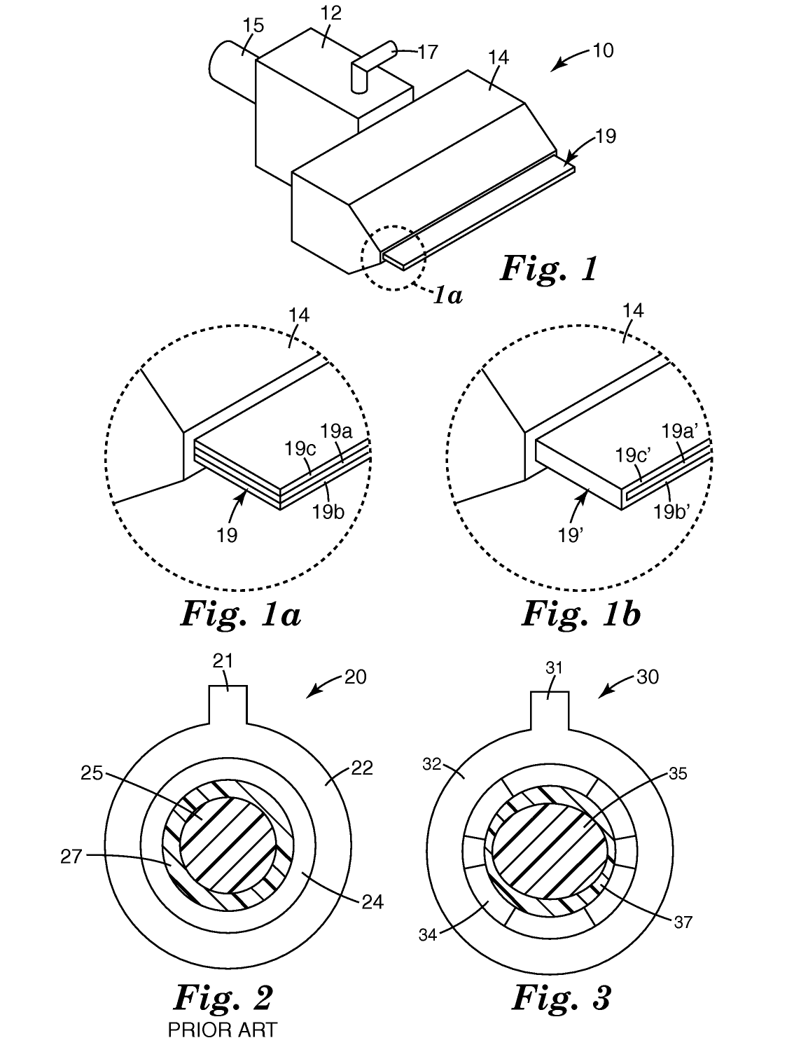

FIG. 1 is a schematic block-like diagram illustrating material flow through an annular feedblock operably connected to a film or sheet die to provide a multi-layered film. The general system 10 includes an annular feedblock 12 upstream from a film or sheet die 14; by use of the term “upstream”, what is intended is that material to be extruded passes through feedblock 12 prior to passing through film or sheet die 14. An extrudable core material 15 enters feedblock 12 axially, passing through the center of feedblock 12. A second extrudable material, a skin material 17, enters feedblock 12 radially, that is, from a radial position. Materials 15, 17 are combined by feedblock 12 to form a composition that has extrudable core material 15 radially surrounded by extrudable skin material 17. This composition progresses to film or sheet die 14 where it is formed into a web 19, which is illustrated idealized in FIG. 1 and FIG. 1a. Web 19 has a center layer 19a formed from core material 15 and outer layers 19b and 19c formed from skin material 17 on either side of center layer 19a. FIG. 1b illustrates a web having a center layer 19a′ surrounded by outer layers 19b′, 19c′, except that center layer 19a′ does not extend to the outermost edge of the web. Rather, center layer 19a′ is encapsulated by outer layers 19b′, 19c′. Such general configurations of system 10 and multi-layer films are generally known.

FIG. 2 shows a schematic diagram of a feedblock 20, similar to yet more detailed than feedblock 12 of FIG. 1, as if viewed from the point of view of film or sheet die 14, looking upstream from film or sheet die 14. Feedblock 20 has an inlet 21 in fluid communication with annular manifold 22. Radially internal to manifold 22 is manifold land 24. Radially internal to land 24 is a volume for receiving extrudable material. The length of land 24 is measured radially, from manifold 22 toward the center of feedblock 20, where extrudable core material 25 flows.

Extrudable core material 25 enters feedblock 20 axially, as illustrated in FIG. 1. In FIG. 2, extrudable core material 25 would be flowing out from the paper. Extrudable skin material 27 enters feedblock 20 via inlet 21 and flows around manifold 22 to provide a continuous ring of extrudable skin material 27. From there, extrudable skin material 27 flows radially inward across land 24, where skin material 27 meets extrudable core material 25 and surrounds it. As the extrudable materials pass through feedblock 20, they form a core/sheath extrudable composition, with core material 25 surrounded by skin material 27.

From feedblock 20, the extrudable composition progresses to film or sheet die 14 (FIG. 1) where it is formed into a multiple layered web 19. Such a process is well known in the web extrusion arts. As is also well known, the resulting three layered web, (e.g., having center layer 19a and outer layers 19b, 19c) is not consistent across the web, i.e., along the length of film or sheet die 14. The thickness of the outer layers 19b, 19c varies across the width of the web. Due to the transition from an annular shape to a flat shape, outer layers 19b, 19c are thinnest in the center area of the web, and thickest at the edges of the web. In other words, the outer layers 19b, 19c increase in thickness as they approach the edges of the web. In many embodiments, this change in thickness is not linear from the center of web 19 to the edges, but is most prevalent at the edges. In some embodiments, as illustrated in FIG. 1b, core layer 19a′ terminates short of the edges leaving only skin layers 19b′, 19c′; outer layers 19b′, 19c′ encapsulate core layer 19a′. In many applications, this edge ‘bead’, having an inadequate core layer and outer layers, is cut off and discarded. Edge beads and other edge discontinuities are formed when extrudable skin material floods the extremities of the die, preventing the core material from reaching the outer edges of the die.

The invention of the present disclosure provides a feedblock that reduces (and preferably eliminates) the edge bead or other edge discontinuities and reduces (and preferably eliminates) the encapsulation at the edges of the web. Referring to FIG. 3, a feedblock 30, generally similar to feedblock 12 of FIG. 1 and feedblock 20 of FIG. 2, is shown as if viewed from the point of view of film or sheet die 14 (FIG. 1) looking upstream. Feedblock 30 has an inlet 31 in fluid communication with manifold 32 that extends annularly around feedblock. Radially internal to manifold 32 is manifold land 34. Radially internal to land 34 is a volume for receiving extrudable material. The length of land 34 is measured radially, from manifold 32 toward the center of feedblock 30. Feedblock 30 differs from feedblock 20, however, in that manifold 32 and land 34 are configured to provide a flow of extrudable material that is different that that from feedblock 20. Specifically, feedblock 30 is configured to provide the extrudable skin material at varying volumetric flow rates around feedblock 30. The volumetric flow rate is adjusted by the geometry of feed block 30.

Similar to feedblock 20, extrudable core material 35 enters feedblock 30 axially, as illustrated in FIG. 1. Extrudable skin material 37 enters feedblock 30 via inlet 31 and flows around manifold 32 to provide a continuous ring of extrudable skin material 37. From there, extrudable skin material 37 flows radially across land 34, where skin material 37 meets extrudable core material 35 and surrounds it. Because of the configuration of manifold 32 and land 34, skin material 37 does not form a consistent thickness ring around core material 35, but rather, forms a 360 degree ring having varying volume or dimensions, e.g., thickness. The volume of extrudable material 37 can be adjusted by modifying manifold 32 and land 34, which is described below.

From feedblock 30 and film or sheet die 14 (FIG. 1), the resulting multiple layered web (e.g., having center layer 19a and outer layers 19b, 19c) is generally consistent across the web, i.e., along the length of film or sheet die 14. The web is consistent for at least the center 95% of the width of the web, with any deviation, if at all present, occurring within 2.5% of either side edge. In other embodiments, the web is consistent for at least the center 98% of the width of the web. In yet other embodiments, any deviation in the consistency is no more than 0.5 inch (about 1.25 cm) from either side edge. In other embodiments, the web deviation is no more than 0.25 inch (about 0.6 cm) from either side edge.

The thickness of outer layers 19b, 19c is generally consistent across the width of the web, and generally, the thickness of core layer 19a is generally consistent across the width of the web. The thickness of each of the layers, e.g., layers 19a, 19b, 19c, is consistent for at least the center 95% of the width of the web, with any deviation, if at all, occurring within 2.5% of each side edge. In other embodiments, the thicknesses are consistent for at least the center 98% of the width of the web. Any deviation in the thickness of any of the layers, e.g., layers 19a, 19b, 19c, is no more than 0.5 inch (about 1.25 cm) from either side edge. In other embodiments, any thickness deviation is no more than 0.25 inch (about 0.6 cm) from either side edge, and even no more than 0.1 inch (about 0.25 cm).

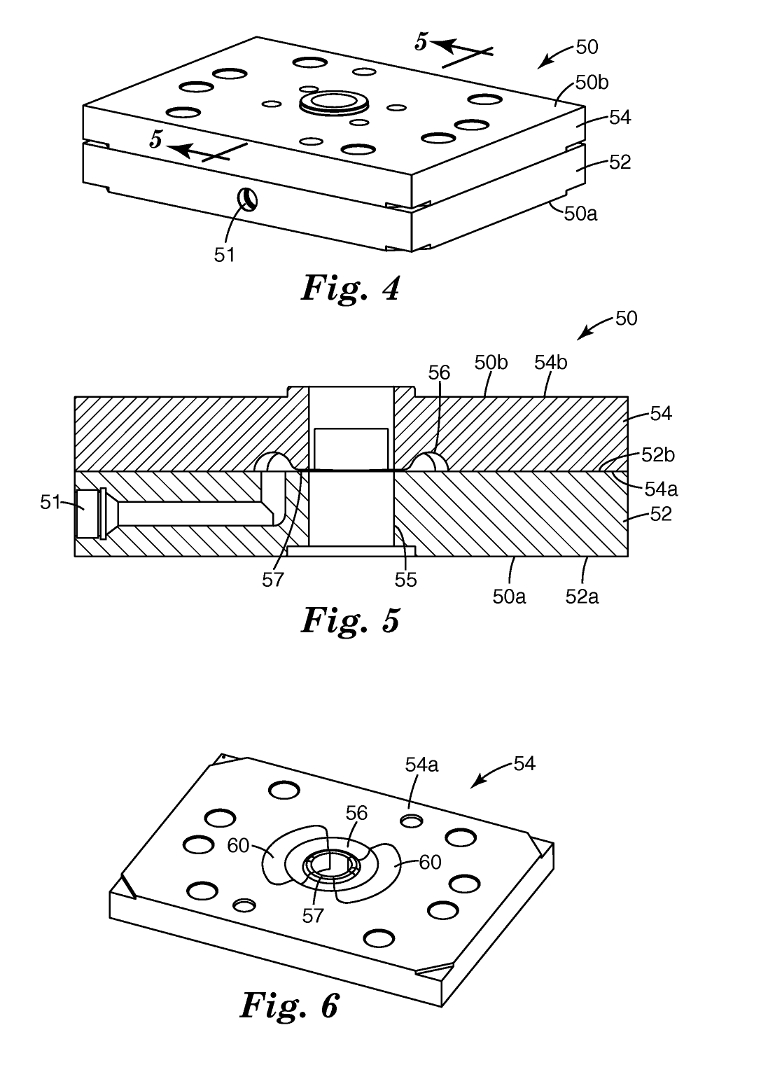

Referring to FIGS. 4 and 5, a feedblock 50, having an upstream side 50a and an opposite downstream side 50b, is illustrated. Feedblock 50 is formed from a first block half 52 and a second block half 54, which are generally connected (e.g., bolted) together.

First half 52, having an upstream side 52a and a downstream side 52b, is upstream of second half 54, which has an upstream side 54a and a downstream side 54b. In this embodiment, upstream side 50a of feedblock 50 is defined by upstream side 52a of block half 52 and downstream side 50b of feedblock 50 is defined by downstream side 54b of block half 54. Sides 52b and 54a contact one another and, as described below, define a portion of the annular manifold of the present invention. A center passage 55 extends through each half 52, 54 through which extrudable core material flows. Feedblock 50 also includes an inlet 51, in this embodiment in half 52, for flow of extrudable skin material into feedblock 50. Within feedblock 50, the extrudable skin material meets the extrudable core material to form a core/sheath extrudable composition, which exits feed block 50 at downstream side 50b.

Feedblock 50 includes a manifold 56 to distribute the extrudable skin material around the extrudable core material in a core/sheath manner to eventually obtain a multi-layered web with generally consistent layer thicknesses across the web. Manifold 56 has a varying geometry and is configured to provide the extrudable skin material at varying volumetric flow rates around feedblock 50. Feedblock 50, in particular upstream surface 54a of second half 54, at least partially defines manifold 56. Manifold 56 includes a land 57, also defined by surface 54a, positioned proximate central passage 55. In use, extrudable skin material passes through the volume defined by manifold 56 and surface 52a and across land 57 to central passage 55 where it surrounds extrudable core material.

To vary the volumetric flow rate of the extrudable skin material as it exits manifold 56, the geometry of land 57, across which the extrudable skin material must pass, varies. In some embodiments, the length of land 57 (i.e., the radial dimension of land 57) varies around central passage 55. In alternate embodiments, the gap between land 57 and surface 52b varies around central passage 55. Land 57 is configured so that the extrudable skin material enters central passage 55 and thus exits feedblock 50 at a lower flow rate at those locations that will form the edges of the resulting flat web than at the center of the resulting flat web.

For ease of understanding the relative positional interaction between the feedblock manifold and the resulting web, the following orientation is used: referring to the schematic of FIG. 3, inlet 31, at the top of the feedblock, is 0°. The portions of the manifold that provide the skin material for the edges of the resulting flat web are at 90° and 270°, and the portions of the manifold that provide extrudable skin material for the center of the resulting flat web are at 0° and 180°. These positions assume that the feedblock is positioned so that 0° is at the top of the feedblock and the film or sheet die is horizontal, in a plane that extends from the 90° position to the 270° position. However, it should be understood that inlet 31 could be positioned at generally any location, as long as the film or sheet die extends from the 90° position to the 270° position.

Feedblock 50 is configured to provide extrudable skin material at lower volumetric flow rates at positions 90° and 270° than at positions 0° and 180°. In some embodiments, the length of land 57 at positions 90° and 270° is longer than at positions 0° and 180°. In other embodiments, the gap between land 57 and surface 52b at positions 90° and 270° is less than at positions 0° and 180°.

The exact length of land 57 and/or the gap between land 57 and surface 52b needed to obtain a resulting film with generally consistent layers depends on the extrudable skin material, on its viscosity, its temperature, its chemical make-up, etc. That is, the geometry of land 57 will vary based on the extrudable skin material used. The features of land 57 may also depend on the resulting extruded web, e.g., the desired thickness of the skin layer, the desired ratio of skin layer to core layer, etc. The features of land 57 may also depend on the core material, its viscosity, temperature, and chemical make-up, etc., as that may affect the flow of the skin material.

To eliminate the need for multiple block halves with different manifold 56 and land 57 configurations, portions of the feedblock can include interchangeable elements, to facilitate changing between the different manifold 56 and land 57 configurations. It is understood that the features described herein directed to modifying the volumetric flow rate of the extrudable material around the manifold apply to a feedblock having permanent elements or removable and interchangeable elements.

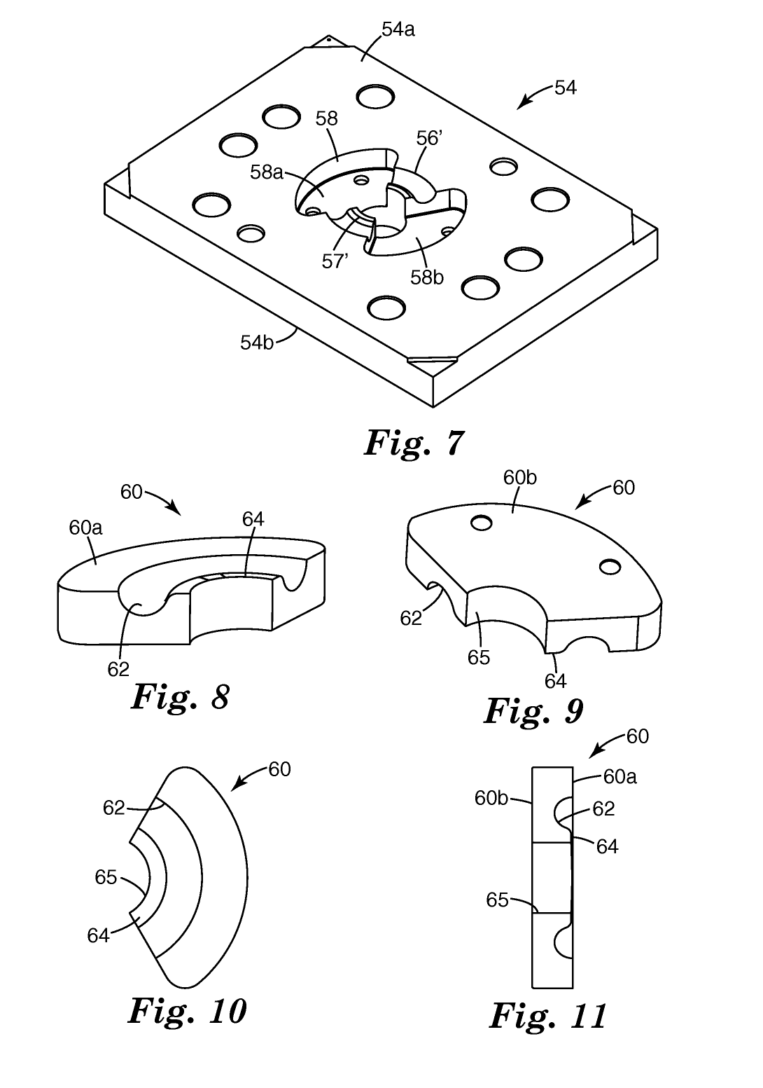

In the embodiment of FIGS. 6 and 7, and as best seen in FIG. 7, second block half 54 includes areas in surface 54a for receiving interchangeable elements that define at least a portion of manifold 56 and land 57. Second half 54 includes recessed area 58 for receiving at least one removable and replaceable element. In the particular embodiment illustrated, surface 54a includes first recess 58a and a second recess 58b, which are mirror images in this design. Recesses 58a, 58b are centered and extend over positions 90° and 270°. Surface 54a remains intact at positions 0° and 180°, between recesses 58a and 58b. Extending between recess 58a and recess 58b, permanently defined in half 54, is a partial manifold channel 56′ and partial land 57′. Recessed area 58, particularly recesses 58a, 58b, are configured to receive insert elements that define the remaining portions of manifold 56 and land 57. FIGS. 8 through 11 illustrate one design for an insert element to be received within recessed area 58 to define portions of manifold 56 and land 57.

Referring to FIGS. 8 through 11, various views of an insert element 60 are illustrated. When inserted into recessed area 58, insert element 60 extends around a portion of central passage 55 (FIG. 5), usually in the area where decreased flow rate of extrudable skin material is desired. FIG. 6 illustrates two insert elements 60 within block half 54.

Insert element 60 is generally at least a 30 degree arc, and in some embodiments, at least a 45 degree arc or at least a 90 degree arc, and in some embodiments, at least a 120 degree arc. In most embodiments, two insert elements 60 are used, one to cover each of position 90° and position 270°. In some embodiments, it may be desired to have the entire manifold 56 and land 57 present on an insert. In such embodiments, an insert may be annular, i.e., 360°, or, for example, two inserts of 180° may be used.

Insert element 60 has a first surface 60a and an opposite second surface 60b. Insert element 60 seats in recessed area 58 with second surface 60b within recessed area 58. Present within first surface 60a is a channel 62 that defines a portion of manifold 56 and a land area 64 that defines a portion of land 57. That is, manifold channel 62 forms a portion of manifold 56 (FIG. 6) and land area 64 forms a portion of land 57 (FIG. 6). When insert elements 60 are provided into recesses 58a, 58b, together, partial manifold channel 56′ and manifold channel 62 define manifold 56, and partial land 57′ and land area 64 define land 57. Insert element 60 includes an edge 65 that defines a portion of central passage 55.

For this embodiment in use, two insert elements 60 are seated in recesses 58a, 58b of block half 54 (as illustrated in FIG. 6) so that when combined with block half 52, the assembly of FIGS. 4 and 5 is made. Extrudable core material 15 passes through central passage 55 simultaneously as extrudable skin material 17 passes through inlet 51 and surrounds central passage 55 by way of manifold 56 (which is formed by manifold channel 56′ in half 54 and manifold channel 62 in inserts 60). From manifold 56, extrudable skin material 17 crosses land 57 (which is formed by partial land 57′ in half 54 and land area 64 in inserts 60) and forms a sheath around extrudable core material 15. From feedblock 50, the combined core/sheath extrudable composition progresses to film or sheet die 14 (FIG. 1) where it is formed into a multiple layered web 19.

For feedblock 50, the geometry of manifold 56 varies, particularly as it relates to manifold land 57.

In some embodiments, the depth or thickness of the land gap (i.e., the distance between land 57 and surface 52b) varies, providing a narrower passage gap for the extrudable skin material that forms the web edges than for the material that forms the web center. Decreasing the thickness of the land gap decreases the amount of extrudable material passing therethrough. Thus, the land gap at positions 90° and 270° (which in this embodiment is on inserts 60) is less than at positions 0° and 180°. The difference at positions 90° and 270°, compared to positions 0° and 180°, will generally be at least 0.05 mm (about 2 mil), often at least 0.125 mm (about 5 mil). In some embodiments, this difference will be at least 0.25 mm (about 10 mil). In some other embodiments, the difference at positions 90° and 270°, compared to positions 0° and 180°, will generally be at least 10%, often at least 20%. In some embodiments, this difference will be at least 25% and sometimes even at least 50%. In some embodiments, the difference may be as much as 100% or even 200%. In another variation, the ratio of the land gap thickness at positions 90° and 270° compared to positions 0° and 180° is at least 1:1.1, over at least 1:1.2. In some embodiments, the ratio is at least 1:1.5, e.g., at least 1:2, at least 1:5, and even at least 1:10. In one particular embodiment, the land gap at positions 0° and 180° is 20 mil (0.5 mm) and at positions 90° and 270° is 10 mil (0.25 mm).

In some other embodiments, the land length (i.e., the distance from manifold 56 to central passage 55) varies, providing a longer distance of travel for the extrudable material that forms the web edges than the material that forms the web center. Increasing the length of the land increases the pressure and thus decreases the amount of extrudable material passing therethrough. Thus, the land length at positions 90° and 270°, at inserts 60, is less than at positions 0° and 180°. The difference at positions 90° and 270°, compared to positions 0° and 180°, will generally be at least 0.1 mm, often at least 0.2 mm. In some embodiments, this difference will be at least 0.5 mm or at least 1 mm. In some other embodiments, the difference at positions 90° and 270°, compared to positions 0° and 180°, will generally be at least 5%, often at least 20%. In some embodiments, this difference will be at least 25% and sometimes even at least 50%.

In some embodiments, the length of the decreased land gap or increased land length extends at least 10° and often at least 20° at each of positions 90° and 270° (that is, the decreased land gap or land length is at least between positions 85°-95° and 265°-275°, and often at least between positions 80°-100° and 260°-280°). In some embodiments, the length of the decreased land gap or increased land length extends at least 30°, e.g., at least 45°, or at least 60°. It is not necessary that the entire land area 64 of insert 60 have the decreased land gap or increased land length; rather, it is suitable that only that a portion of land area 64 is configured to provide the increased pressure and thus decreased flow of extrudable material.

The transition from the locations (i.e., positions 90° and 270°) having the decreased land gap or increased land length to the other locations (i.e., positions 0° and 180°) in most embodiments is a gradual transition rather than a step. In some embodiments the transition is linear and in other embodiments the transition is non-linear, e.g., parabolic.

By providing an annular manifold that can provide less material flow at the sides of the resulting extruded web, a generally even or generally consistent multi-layered web is obtained.

A feedblock of the present invention, such as feedblock 50, is configured to be operably engaged with a film or sheet die block to provide a multi-layered film or web of polymeric material, such as web 19 of FIG. 1.

The extrudable materials that can be used with feedblock 50 are broadly referred to as plastic or polymeric materials, and include materials such as thermoplastic polyurethane, polyvinyl chloride, polyamides, polyimides, polyolefins (e.g., polyethylene and polypropylene), polyesters (e.g. polyethylene terephthalate), polystyrene, nylons, acetals, block polymers (e.g., polystyrene materials with elastomeric segments), polycarbonate, thermoplastic elastomers, and copolymers and blends thereof. The extrudable materials may contain optional additives such as fillers, fibers, antistatic agents, lubricants, wetting agents, surfactants, pigments, dyes, coupling agents, plasticizers, and the like. The extrudable skin material may be different or the same as the extrudable core material.

The resulting multi-layer web is usually about 0.5 mil (about 0.013 mm) to about 100 mil (about 2.5 mm) in thickness, although thinner and thicker webs are within the scope of this invention. In most embodiments, the web will have three layers (i.e., a core and two skin layers), although other embodiments of webs may include more than three layers. For example, a five layer film can be made, e.g., by having two feedblocks in series. Webs with an even number of layers could also be made. In some instances, the thickness of the skin layers is the same or similar to the thickness of the core layer, whereas in other instances the thickness will differ. For example, one representative three-layer film is a 25/50/25 combination of skin/core/skin, another example is 5/90/5, and yet another example is 12.5/75/12.5.

In some embodiments, the feedblock of the present invention provides a multi-layered web that is generally consistent across the width of the web. Additionally or alternatively, the feedblock of the present invention provides a multi-layered web that has each layer generally consistent across the width of the web; that is, each layer, individually, is generally consistent across the width of the web.

An Exemplary Feedblock with Inserts and Use Thereof

One exemplary feedblock with removable insert elements, similar to feedblock 50 with insert elements 60, was made. The feedblock included a first block similar to block half 52 and a second block similar to block half 54. Each block was about 1 inch (about 2.5 cm) thick and was about 9 inches (about 22.9 cm) by about 6.5 inches (16.5 cm) in size. The first block had a central passage similar to central passage 55 and an inlet at the 180° position. The inlet did not connect to central passage 55 but rather exited out a side of the first block, similar to side 52b of FIG. 5. The second block had two identical recesses, similar to recesses 58a, 58b, for receiving the two insert elements therein.

Each of the insert elements was similar to insert element 60 of FIGS. 8-11. Each insert element was a 120° segment, with the outer perimeter defined by a radius of about 1.7 inches (about 4.3 cm) and an inner perimeter, that also defined the central passage, of about 1 inch (about 2.5 cm). Each insert element had a concave channel, similar to manifold channel 62, having a radius of 0.225 inch (about 5.7 mm) with a maximum depth of about 0.225 inch (about 5.7 mm) positioned about 0.92 inch (2.3 cm) from a central radius point for the insert. A land area, similar to land area 64, was present between the concave manifold channel and the inner perimeter. The transition between land area 64 and manifold channel 62 was radiused, at a 0.095 inch (about 2.4 mm) radius. The level of the land area was 0.01 to 0.02 inch (about 0.25 mm to 0.5 mm) below the level on the other side of the concave manifold channel. At the central 20° of the channel, the land was 0.01 inch lower and linearly tapered to being 0.02 inch lower.

The two blocks, with the two inserts present in the recesses, were bolted together to form an arrangement similar to that shown in FIG. 4.

The assembled feedblock was operably connected to two extruders. The extruder that supplied extrudable core material (15 melt flow index polypropylene-polyethylene impact copolymer and red pigment) to the central passage of the feedblock was a 3.5 inch (about 8.9 cm) extruder operating at 50 rpm and 200 pounds/hour (about 90.8 kg/hour) of material. The extruder that supplied extrudable skin material (15 melt flow index polypropylene-polyethylene impact copolymer) via the inlet in the first block was a 1.5 inch (about 3.8 cm) extruder operating at 75 rpm and 25 pounds/hour (about 11.4 kg/hour) of material. In the feedblock, the two extrudable streams formed a core/sheath configuration and from there were fed into a standard film or sheet die.

A three-layer film, 30.5 inches (about 77.5 cm) wide, was extruded at a rate of 43 meters/minute. The resulting film had a basis weight of about 130 grams/m² and a 5/90/5 ratio of skin/core/skin.

The three-layer film was visually observed to have consistent color across the web width. It is believed that a very small amount of only clear material may have been present at the outermost edges (i.e., no core material was present at the outermost edges), although this was not visually discernable by visual observation.

A conventional three-layered film was made using conventional extrusion techniques using a feedblock with a conventional straight manifold. It was visually obvious that the pigmented core material did not extend to the edges of the film, but rather, only the clear skin material was present from the edge to about 0.5 inch (about 1.3 cm) into the web.

The experimental film and the convention film were both analyzed for color in the films. Samples of the films were scanned at 200 pixel/inch with a flatbed scanner for color analysis. For both samples, the very outer edges of the film were clear, and the internal portion of the film was pigmented and opaque, due to the pigment present in the core layers. The color index of the film was determined using Adobe Photoshop software in 8-bit RGB color, and the color content was output as a RAW format file. This file was then input into Microsoft Excel for color analysis. The mean color index for each row of pixels parallel to the edge of the film was found by averaging pixels over 2 inches (about 5 cm) of film (thus providing 400 pixels).

From this analysis, the average 8-bit red color index (RGB Color) was determined at three locations: (1) at the clear edge of each side of the film sample; (2) about 1 inch (about 2.5 cm) inside from the edge of each side of the film sample, and (3) at regular intervals with a spacing of 0.005 inch (about 0.13 mm) (for the pixels 200 rows in the scanned image).

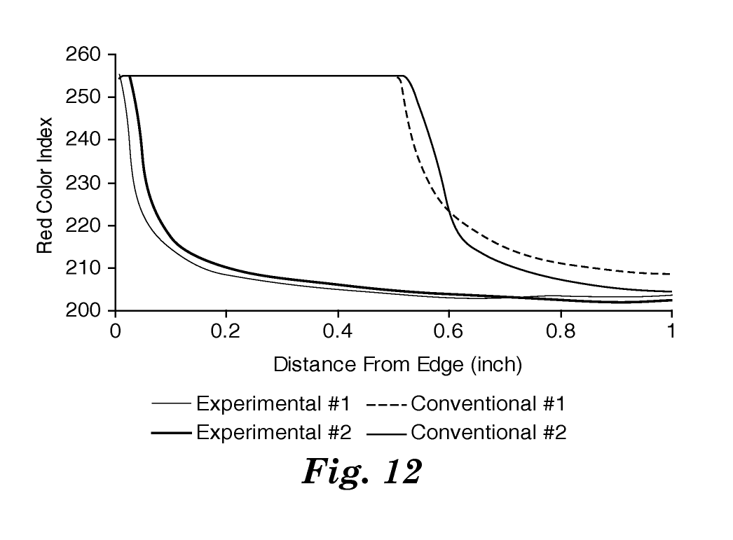

Only the Red Color index, “R value” (scaled from 0 to 255) was used as an indication of pigment saturation, because the pigment present in the core was red. The maximum and minimum R values found were 202 and 255, respectively, with the maximum R index corresponding to the clear edge of the film and the minimum R index corresponding to the color 1 inch (2.5 cm) away from the edge. The effective unusable film width was determined at the row where the R index changed by 25% above the minimum, i.e., R=Rₘᵢₙ+0.25(Rₘₐₓ−Rₘᵢₙ), which was R=215. The minimum distance from the edge to this target R value for the two edges of the samples were determined, and the results were tabulated and averaged and are reported below. FIG. 12 shows generalized curves for the individual data points recorded.

| Sample | distance from edge | edge |
|---|---|---|
| Conventional | 0.67 inch | #1 |
| Conventional | 0.63 inch | #2 |
| Conventional average | 0.65 inch | |
| Experimental | 0.08 inch | #1 |
| Experimental | 0.12 inch | #2 |
| Experimental average | 0.10 inch | |

The film made with the conventional feedblock, having a straight manifold without a taper, had an edge bead width of 0.65 inch (about 1.65 cm) on each side, whereas the film made with the inventive feedblock, having a tapered manifold, had an edge bead width of 0.10 inch (about 0.25 cm). The tapered manifold was advantageous in producing more usable product off the same roll width and reducing recycle or scrap material.

The above specification, examples and data provide a complete description of the manufacture and use of the composition of the invention. Since many embodiments of the invention can be made without departing from the spirit and scope of the invention, the invention resides in the claims hereinafter appended.

What is claimed:

1. A method of extruding a multiple layer film, comprising:
(a) providing an annular feedblock in flow communication with a film or sheet die, the annular feedblock having: a first portion having a first manifold portion with a first land and a second portion having a second manifold portion with a second land, the first land being different than the second land;
(b) feeding a first extrudable material axially through the feedblock and simultaneously feeding a second extrudable material radially into the feedblock;
(c) extruding the second extrudable material from the manifold across the first land and the second land in an annular form around the first extrudable material to provide a combined extrudable stream; and
(d) passing the extrudable stream through the film or sheet die to form a multiple layer film.

2. The method of claim 1, wherein extruding the second extrudable material from the manifold comprises:
(a) extruding the second extrudable material from the manifold and across the first land and the second land at different volumetric flow rates.

3. The method of claim 1, wherein providing an annular feedblock having the first land being different than the second land comprises:
(a) providing an annular feedblock having the first land a different length than the second land.

4. The method of claim 3, wherein providing an annular feedblock having the first land a different length than the second land comprises:
(a) passing the second extrudable material across the first land to form edges of the film and across the second land to form a center of the film, wherein the first land is longer than the second land.

5. The method of claim 1, wherein providing an annular feedblock having the first land being different than the second land comprises:
(a) providing an annular feedblock having a first gap defined by the first land and a second gap, different than the first gap, defined by the second land.

6. The method of claim 5, wherein providing an annular feedblock with the first gap different than the second gap comprises:
(a) passing the second extrudable material across through first gap to form edges of the film and through the second gap to form a center of the film, wherein the first gap is less than the second gap.

7. The method of claim 6, wherein the first gap and the second gap form a ratio of at least 1:1.1.

8. The method of claim 6, wherein the first gap and the second gap form a ratio of at least 1:1.2.

9. The method of claim 6, wherein the first gap and the second gap form a ratio of at least 1:2.

10. The method of claim 6, wherein the first gap is at least 0.125 mm less than the second gap.

11. The method of claim 6, wherein the first gap is at least 0.25 mm less than the second gap.

12. The method of claim 5, wherein the land comprises a transition region between the first gap and the second gap.

13. An annular feedblock comprising:
a first block half and a second block half adapted to be joined to the first block half, and
an annular manifold between the first block half and the second block half, the manifold having a land, with the manifold and the land at least partially defined by an insert element removable from the second block half.

14. The annular feedblock of claim 13 wherein the manifold and the land are at least partially defined by the at least one insert element and at least partially defined by the second block half.

15. The annular feedblock of claim 14 wherein the manifold and the land has a geometry that differs between the second block half and the at least one insert element.

16. The annular feedblock of claim 13 wherein the at least one insert element has an arc of 30°-360°.

17. An annular feedblock comprising:
a first block half and a second block half adapted to be joined to the first block half, and
an annular manifold between the first block half and the second block half, the annular manifold having a first portion with a first land and a second portion with a second land, the first land being different than the second land.

18. The annular feedblock of claim 17 wherein the first land is longer than the second land.

19. The annular feedblock of claim 17 wherein the first land defines a first gap that is less than a second gap defined by the second land.

20. The annular feedblock of claim 17 further comprising a tapered area between the first land and the second land.
